(19) United States
(12) Patent Application Publication
(10) Pub. No.: US 2006/0048011 A1
(43) Pub. Date: Mar. 2, 2006

(54) Performance profiling of microprocessor systems using debug hardware and performance monitor

(75) Inventors: James N. Dieffenderfer, Apex, NC (US); Sanjay B. Patel, Cary, NC (US); Brian M. Stempel, Raleigh, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 10/926,566

(22) Filed: Aug. 26, 2004

(51) Int. Cl. G06F 11/00

(52) U.S. Cl. 714/38

(57) ABSTRACT

A method and system for monitoring the real-time of software running on a microprocessor system. Debug hardware is used to select a range of instructions or events to be monitored by a performance monitor interval with the microprocessor system. A comparison is made between each event and start and stop events are identified in the debug hardware. The performance monitor is enabled by the debug hardware, when events occur within the range defined by the debug hardware. Use of the debug hardware for enabling performance monitoring avoids any overhead associated with generating interrupts, or additional code in the application program.

### BACKGROUND OF THE INVENTION

The present invention relates to systems for diagnosing problems in microprocessor computing systems. Specifically, a system which provides performance profiling through the cooperation of debug hardware and a performance monitor of a microprocessor system is disclosed.

Microprocessor systems are used in applications where specific software modules are executed having real-time performance constraints that are timing critical. For example, in a cellular telephone application that has voice recognition capabilities, the audio must be saved and processed in sufficient time to keep up with human speech patterns. In applications such as a hard disk controller, the magnetic head must be tracked reliably in real-time to prevent damage to the disk being written with data. Application software which is subject to these real-time system constraints can be verified in either a simulation or emulation of the application software. This requires a time consuming and costly approach to recreate a model of the system, including all real world variables that may be encountered when the application is executed. Further, because of the cost constraints, the model may have limited throughput lessening the value of this approach to validating the system against real-time constraints.

Many microprocessing systems include performance monitors which can measure events identified through starting and end points of code being executed under test. This requires that the application source code be invasively modified to include the starting and end points for the monitor to begin and end analysis of code being executed. Further, it is generally difficult to filter performance monitor data unless the region within which the events are counted is precisely defined.

As an additional technique for verifying performance against real-time constraints, a trace port may be added to the microprocessor system which provides a method to analyze software execution through an external logic analyzer or other digital tool. The additional equipment and software necessary to post process any data recovered through the trace port provides an additional cost which is objectionable.

U.S. Pat. No. 5,774,724 describes a type of system which is used to monitor the performance of a computing system with improved granularity. The earlier patent describes the use of a single break point register where both a start and stop break point instruction address are inserted to define a useful address range for monitoring software execution. The system break point register includes a start break point, and when an interrupt occurs when the start address has been detected in the instruction address register, the interrupt handler reprograms the break point register with a stop address. The interrupt occurs during execution of the code being counted by the performance monitor hardware thereby polluting the performance results of the executed code. A code module may also have multiple entry points that a single start break point register cannot detect, and events may not be counted since the code region being monitored may not have entered at the start address. Further, the code module may have multiple exit points that a single stop point register cannot detect. This would result in an over counting of events since the counting continues until the module is re-entered and exits through the identified stop break point address. The use of interrupts also reduces computational bandwidth for the application and is otherwise invasive. Additionally, the system must alter the source code of the application which is then recompiled into the code image.

Because of these and other disadvantages, the present invention has been provided which makes use of the existing debug hardware and performance monitor, and which does not require the use of interrupts and the interrupt handler.

### BRIEF SUMMARY OF THE INVENTION

A method and apparatus are disclosed which provides for performance monitoring during execution of a microprocessor program. An interface is provided between on board debug hardware and an on board performance monitor for selecting events which occur during execution of the program defining a beginning and end to a monitoring interval. The processor on board performance monitor is enabled and disabled by an enable and disable signal produced at the beginning and end of the monitoring interval.

In accordance with a preferred embodiment of the invention, the interface includes a programmable performance monitor debug register which identifies a plurality of events which occur during program execution. Each of the debug hardware detected events is supplied to first and second multiplexers. When these events occur, a first and second multiplexer are enabled by the performance monitor debug register to generate the enable and disable signal.

### BRIEF DESCRIPTION OF THE DRAWINGS

FIG. 1 is a block diagram of a microprocessor system which incorporates a preferred embodiment of the invention;

FIG. 2 illustrates the performance monitoring debug control register and interface between the debug hardware and the performance monitor.

FIG. 3 is a block diagram showing the performance monitor for monitoring events being executed in a microprocessor system;

FIG. 4 illustrates the organization of the debug control register for selecting events for monitoring;

### DESCRIPTION OF THE PREFERRED EMBODIMENT

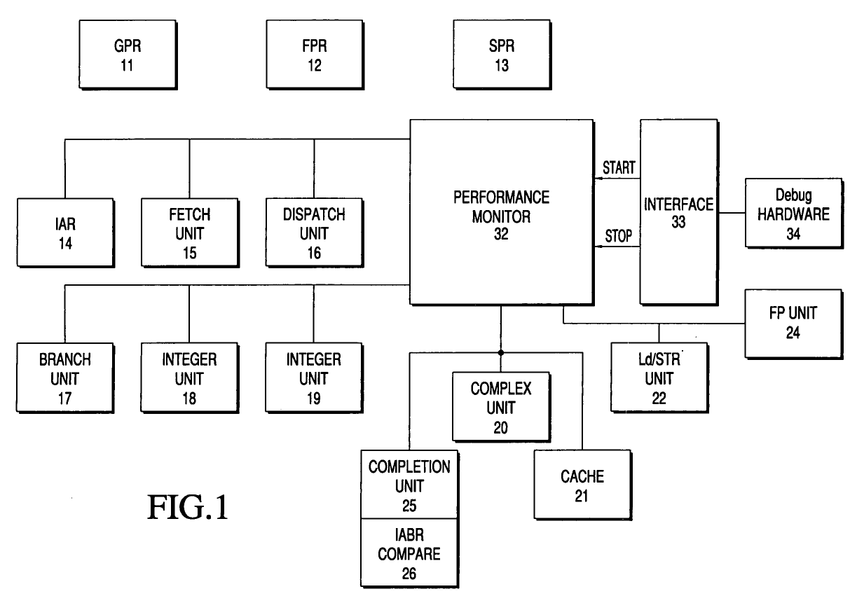

Referring now to FIG. 1, the microprocessor system of FIG. 1 includes various registers such as a general purpose register 11, floating point registers 12, and special purpose registers 13. The microprocessor also includes numerous processor units performing their own conventional tasks such as fetch unit 15, dispatch unit 16, branch unit 17, integer unit 18, integer unit 19, complex unit 20, cache 21, a load cache/store unit 22, a floating point unit 24, completion unit 25 and the JABR compare unit 26.

The microprocessor system of FIG. 1 includes a performance monitor 32 as well as debug hardware 34. The performance monitor allows the execution of a program by the microprocessor system to be monitored. The debug hardware performs the various debug operation encountered during hardware and software development. The debug operations and debug events are selected by programmable registers in the debug hardware. One example of the debug hardware is described more completely in the user's manual for the PowerPC PPC403 GB embedded controller which is published by the International Business Machines Corporation.

The function of the performance monitor is to monitor and count pre-selected events such as processor clocks, cache misses, instructions dispatched to a particular execution unit, instruction per cycle time of execution, etc. The performance monitor permits a real-time evaluation of software code during execution and facilitates increased system performance by enabling the design of more efficient processors and software. The typical performance monitor 32 includes counter registers which can be used to time events or count events produced during program execution.

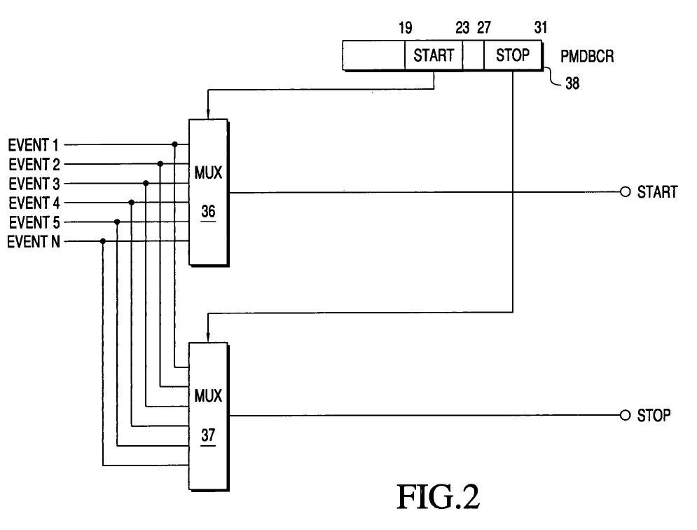

In accordance with a preferred embodiment of the invention, an interface 33 is provided between the debug hardware 34 and performance monitor 32 as shown more particularly in FIG. 2. Referring now to FIG. 2, a performance monitor debug control register (PMDBCR) selects start and stop events defining an interval of a program being executed to be monitored. The contents of the register PMDBCR are shown more particularly TABLE 1.

TABLE 1

| 0:18 | | Reserved |
|---|---|---|
| 19:23 | STRT [0:4] | Start Debug Event |
| | | 00000-IAC1 |
| | | 00001-IAC2 |
| | | 00010-IAC3 |
| | | 00011-IAC4 |
| | | 00100-DAC1R |
| | | 00101-DAC1W |
| | | 10001-Trap |
| | | 10010-Intrpt |
| | | 10011-BT |
| | | 10100-11111 Reserved |
| 24:26 | | Reserved |
| 27:31 | STOP [0:4] | Stop/Pause Debug Event |
| | 00001 | 00000-IAC1 |
| | | 00001-IAC2 |
| | | 00010-IAC3 |
| | | 00011-IAC4 |
| | | 00100-DAC1R |
| | | 00101-DAC1W |
| | | 10001-Trap |
| | | 10010-Intrpt |
| | | 10011-BT |
| | | 10100-11111 Reserved |

As shown in TABLE 1, the start addresses 19:23 can hold up-to five bits which can identify a debug event which marks the beginning of a performance monitoring interval of a program being executed by the microprocessor system. The performance monitor is enabled by a start signal when one of the events defined in locations 19:23 is detected by the debug hardware. These events may include execution of a particular instruction address IACI, IAC2, IAC3 or IAC4. A similar register, the Debug Control Hardware Register DCHR, in the debug hardware is programmed to control a comparison operation between the instruction address register for the instruction to be executed and a selected instruction address. As will be evident from the description of the debug hardware, the selected instruction address can be programmed in the debug hardware for each of IACI, IAC2, IAC3 or IAC4 which identifies the selected instruction address to the debug hardware.

Other events identified in Table 1 which may initiate monitoring include data being read or being written (DAC1R, DAC1W, etc.), the execution of a trap instruction (Trap), an interrupt (Intrp) and a branch taken (BT). The selected address for defining the debug event is programmed in a data register of the debug hardware by the user.

The PMDBCR register further includes a stop event identified in addresses 27:31 marking the end of the monitored portion of the program execution which generates a stop signal for the performance monitor. These also include up-to four instruction addresses (IAC1-IAC4), data addresses (DAC1-DAC2, both written and read), Trap, interrupt (Intrp) and a branch taken (BT). The contents of the performance monitor debug control register of Table 1 are exemplary only. Other events identifying the execution sequence to be monitored may be identified in the PMDBCR register as a start event, and a stop event.

FIG. 2 shows how the PMDBCR register programmed in accordance with Table 1 controls two multiplexers 36 and 37. The start and stop events are defined in the PMDCR register at bit locations 19-32 and 27-31 as shown in Table 1. Each of the multiplexers 36, 37 receives the debug event defined by the debug hardware which either begin or end a performance monitor measuring interval. As shown in Table 1, selection of a start event is made by storing the appropriate code in locations 19-23. Similarly, the stop event is identified in the PMDCR register locations 27-31 representing the event of interest.

An enable and disable signal is provided by each of multiplexers 36 and 37 when the defined start and stop event is encountered by the debug hardware to provide start/stop signals for the performance monitor.

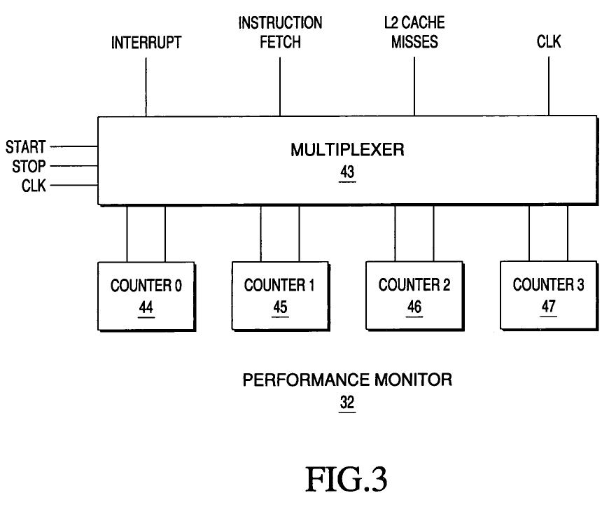

FIG. 3 shows a block diagram of a performance monitor 32. Performance monitor 32 counts processing events such as interrupts, L2 cache misses, load/store events, clock pulses, to name just a few. A multiplexer 43 is programmable so that any one of counters 44-47 may be programmed to count any selected event. Start and stop pulses are received by the performance monitor from the interface of FIG. 2, which result in an enable and disable (e/d) of a counter which is counting events on the input (c) of a selected counter.

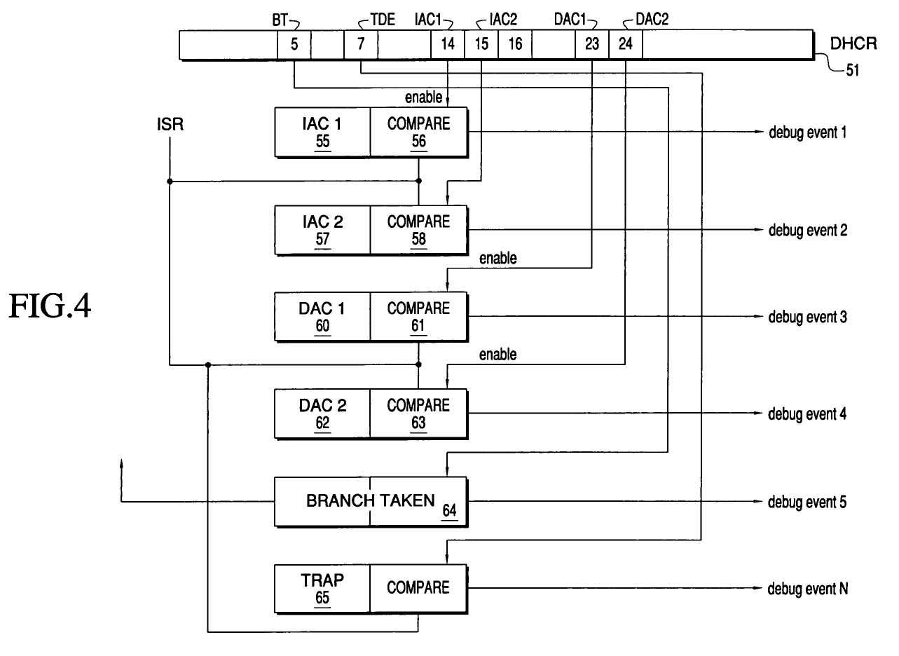

The conventional on board debug hardware is illustrated in schematic form in FIG. 4. Referring now to FIG. 4, a debug hardware control register (DHCR) 51 is shown programmed to identify debug events occurring during execution of the microprocessor computer program. A single bit in the respective position of the DHCR 51 identifies a selected debug event. For instance, bit number 5 is shown as a position reserved for monitoring a BRANCH TAKEN debug event. In the event that a program under execution branches, in accordance with the branching instruction, this debug event will be generated by hardware 64 which detects the branch taken event. A TRAP DEBUG event may be set in the DHCR 51 by setting a bit in the position number 7. In this condition, the execution of a trap instruction identified in register 65 is detected by compare logic associated with register 44, and results in a debug event N.

The selection of some debug events, such as an instruction which is being executed IAC1, and IAC2, or data being read or written to, DAC1, DAC2, require the selected data or address to be programmed in the debug hardware. If the IAC1 bit in location 14 is set, an instruction address is programmed into register 55. The system program counter PC is monitored, and when the selected instruction is executed, compare logic 56 associated with register 55 issues debug event 1. When the bit in location 15 of DHCR 51 is set to 1, a second selected instruction IAC2, whose address is programmed into register 57, is monitored. When the compare logic 58 associated with register 57 indicates that the system PC has produced the selected instruction address, debug event 2 is generated.

Each of these two debug events require the programmer to enter an address of the particular instruction IAC1 and IAC2 to be monitored into registers 55, 57. When the processor executes the identified instruction, debug event 1 or debug event 2 is produced from compare logic 56 and 58 associated with each of the registers 55 and 57.

FIG. 4 illustrates the provision of a data address compare feature, where the debug event is defined as the execution of an instruction that accesses a data address DAC. The data addresses such as DAC1 and DAC2 are programmed by the debug software in registers 60, and 62. When one of the data addresses is accessed by the processor while executing a program, the compare logic 61 and 63 associated with registers 60 and 62 generates a debug event 3 or 4.

The debug hardware control register (DHBCR) 51 and programming of the debug hardware is described more particularly in Chapter 8 of the “PowerPC PPC403 GB Embedded Controller User's Manual,” which is published by the International Business Machines Corporation. As set forth in the foregoing user's manual, still other events may be defined by the debug control register 51 for monitoring events which occur during execution of a program by the microprocessor system.

Table 2 is an example of how the debug hardware is programmed to monitor a common subroutine instruction sequence. The debug event for starting monitoring is a beginning IAC1 address of 1020, and an ending IAC2 address 1221. A programming step for setting the contents of the PMDCR is shown so that the appropriate data is entered in locations 19-23 and 27-31 to identify a beginning instruction address and an ending instruction address. Similarly, the debug DHCR register 41 and the respective IAC1, IAC 2 registers 55 and 57 are programmed with the instructions MTSPR

TABLE 2

| | |
|---|---|
| Select Debug Event 1 | MTSPR IAC1, 1020 |
| Select Debug Event 2 | MTSPR IAC2, 1221 |
| Set PMDCR | PMDCR; 0000[19,23] 00001 [27,31] |

WHERE:
1020 is the first instruction of the subroutine; and
1221 is the last instruction of the subroutine.

In this scenario, the debug hardware will provide an output from the compare logic 56 and 58 when the appropriate instruction has been fetched for execution by the program being monitored.

It should be noted that if execution of a program leaves the subroutine, the interval continues until execution returns and the IAC2 instruction is executed.

The preferred embodiment of the invention permits the debug hardware to interface with the performance monitor using the existing debug hardware as well as the exiting performance monitor. The foregoing is non-invasive, in that no extra instructions needs to be placed in the application source code, nor does any interrupt handling become necessary to begin monitoring any particular range of events.

The foregoing description of the invention illustrates and describes the present invention. Additionally, the disclosure shows and describes only the preferred embodiments of the invention in the context of a performance profiling of microprocessor systems using debug hardware and performance monitor, but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form or application disclosed herein. Also, it is intended that the appended claims be construed to include alternative embodiments.

1. A method for monitoring the real time performance of software running on a microprocessor comprising:
using debug hardware to select a range of instructions being executed on said microprocessor;
comparing each instruction with said range of instructions to determine when instructions within said range are being executed; and
monitoring execution of software running on said microprocessor when instructions within said range are being executed.

2. The method according to claim 1 wherein said step of selecting said range of instructions comprises:
selecting a first instruction which identifies the beginning of said range;
storing said first instruction in a first register of said debug hardware;
selecting a second instruction which identifies the end of said range; and
storing said second instruction in a second register of said debug hardware.

3. The method according to claim 2 further comprising:
comparing in said debug hardware logic said first and second instructions with the contents of the instruction register of said microprocessor;
enabling a trace monitor to monitor events produced during execution of said software when said instruction register produces an instruction within a range defined by said first and second instruction; and
disabling said trace monitor when said instruction register produces an instruction outside of said range

4. The method according to claim 1 wherein said monitor counts cache misses which occur during execution of instructions within said range.

5. A system for monitoring the real-time performance of microprocessor program execution comprising:
debug hardware having a register for receiving first and second addresses defining the beginning and end of a instruction sequence; and
a monitor connected to said debug hardware and to said microprocessor, said monitor being enabled by said debug hardware to count events produced when said debug hardware detects addresses within said sequence is being executed.

6. The system for monitoring the performance of a microprocessor program execution according to claim 5 wherein said debug hardware includes a compare circuit for comparing the contents of said first and second registers with addresses produced by said microprocessor during program execution, and logic circuitry for enabling and disabling said monitor when said addresses are produced by said microprocessor.

7. The system for monitoring the performance of microprocessor program execution according to claim 5 wherein said monitor counts cache misses which occur during execution of said program

8. The system for monitoring the performance of microprocessor program execution according to claim 6 wherein said performance monitor is enabled to monitor events when said program instructions executes instructions out side of said range and
returns to execute instructions within said range.

9. A system for monitoring the real time performance of a microprocessor program execution comprising:
a performance monitor debug control register which includes first and second address portions for storing the identity of an event which is identifies a beginning and end of a performance monitoring interval;
a first and second multiplexer which are enabled by said register to generate an enable and disable signal when an event corresponding to said identified events occurs;
debug hardware which is programmable to produce a plurality of signals corresponding to events which occur during execution of said microprocessor program, said signals being connected to said multiplexers; and
a performance monitor connected to count events which occur during execution of said microprocessor program, said performance monitor being enabled by first and second signals produced by said multiplexers.

10. The system according to claim 9 wherein one of said events identified by said control register is an instruction address in said microprocessor program.

11. The system according to claim 9 wherein one of said events is an address of data which is accessed during execution of said microprocessor program.

12. The system according to claim 9 wherein one of said events is an execution of a trap instruction.

13. The system according to claim 9 wherein one of said events is execution of a branch instruction by said microprocessor program.

14. The system according to claim 10 wherein said debug hardware includes a programmable address register which identifies the instruction address of a program being executed by said processor which generates an event when it is executed.
